(19) United States
(12) Patent Application Publication
(10) Pub. No.: US 2011/0221709 A1
(43) Pub. Date: Sep. 15, 2011

(54) Electrically Conductive Accessory System for Non-Electrically Conductive Glove

(76) Inventors: Min Yao, (US); Min Guo, (US)

(21) Appl. No.: 12/723,685

(22) Filed: Mar. 15, 2010

(51) Int. Cl. G06F 3/033

(52) U.S. Cl. 345/179

(57) ABSTRACT

This invention is directed to an accessory system including an outer touch component and inner locking component that transmits user inputs an electronic device through a conductive material.

An outer touch component has a tip that stays between electronic device and a barrier material such as glove or apparel. Its root extends through the barrier material and connects the inner locking component.

The locking component holds the root part of the touch component, through various mechanisms such as mechanically locked by screw thread, trap, etc or chemically bonding using glues or adhesives.

Both outer touch component and inner locking component are made of conductive material, such as metal or conductive polymer. The touch tip part may be covered with conductive material, such as conductive fabric or thread, or coated with conductive plastic/polymer/rubber/gel.

The distance between the outer touch component and inner locking component can be adjusted to fit various substrate material and thickness.

### BACKGROUND OF THE INVENTION

This relates to an accessory system that allows electron flow through a non conductive barrier without creating an aperture on the barrier material, removing or destroying the barrier. The non-conductive barrier can be, but not limited to, glove, apparel and other substrate barrier between human body and the environment.

The touch screen technology has been used widely in many areas, particularly electronic devices (e.g., instrument control panels, cellular telephones and personal media players such as the MP3 player). In many cases, users' hands are covered or protected by glove or other protective barrier materials that are not conductive. In order to operate an electronic device that requires electron flow, the barrier between user finger and electronic device needs to be conductive. With a non conductive barrier layer such as glove, it may become difficult to operate the electronic device.

In order to operate the electronic device with touch screen precisely, it requires the direct contact of finger with the screen. During the cold weather or emergent cases, it is difficult to manipulate the device. In some cases, it is impossible to take off the glove or remove the protective barrier. In the cold weather, operating electronic device with bare hand can be frustrating. The non conductive layer can also accumulate static charges. In some cases it can release high voltage when contacting the surface with opposite charge, which can be problematic and dangerous.

Accordingly, there is a need for an accessory system with which a user or manufacturer can install it to a non-conductive barrier and provide input mechanism of an electronic device to perform operations. The current art described in Patent Application 2009000010 described a method of two layer system, an inner layer and an outer liner. The glove also has an aperture to allow inner layer, which is conductive, to extend to control the electronic device. Such products increase the complexity of manufacturing process and product cost. Users can't use their current glove product but have to live with the few options available on the market. There is a need to create an accessory system to users can add to their favorite gloves or particular gloves for certain events such as skiing, or skating. There is also a need to create a removable accessory that can be taken off when no longer needed.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of an illustrative outer touch point/tip for use in a glove in accordance with one embodiment of the invention; The touch point/tip can be a half ball shape or any other shape that provides easy operation on electronic device.

FIG. 2 is a cross-sectional view of a touch point/tip with one embodiment of the invention.

FIG. 3 is a cross-sectional view of an outer touch component root part with one embodiment of the invention. It has screw thread.

FIG. 4 is a cross-sectional view of an inner locking component with one embodiment of the invention. It has screw thread that matches that on the outer touch component root.

FIG. 5 is a cross-sectional view of an outer touch component root part with one embodiment of the invention. It has etched lines.

FIG. 6 is a cross-sectional view of an inner locking component with one embodiment of the invention. It has an aperture that traps the root at the etched lines.

FIG. 7 is a cross-sectional view of an outer touch component root part with one embodiment of the invention. It has protruding dots.

FIG. 8 is a cross-sectional view of an inner locking component with one embodiment of the invention. It has protruding dots to lock the outer touch component root when it enters into the locking component.

FIG. 9 is a cross-sectional view of an accessory set in use with one embodiment of the invention. The barrier layer is securely locked between the outer touch component and inner locking component.

FIG. 10 is cross-sectional view of an inner locking component with an elastic band that can secure finger during use.

FIG. 11 is cross-sectional view of an inner locking component with an edge extending out in an angle to secure the finger during the electronic device operation.

### DETAILED DESCRIPTION

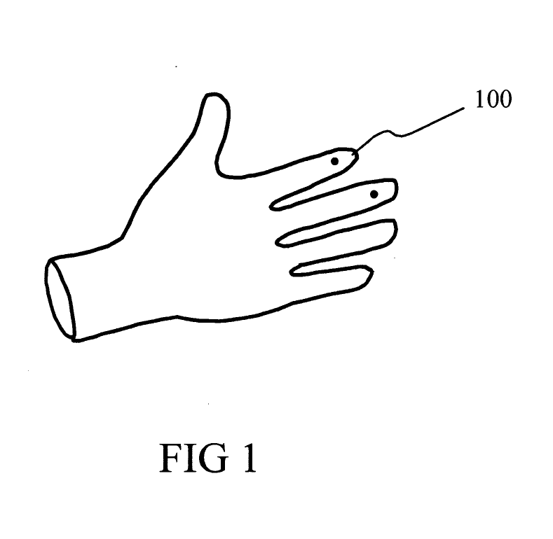

FIG. 1 is a schematic view of an illustrative glove with the invented accessory. Only the outer touch component 100 is visible from outside. The glove/barrier/insulation material can consist of one single layer or multi layers, depending on its end uses. It can be made of genuine leather, man-made leather, cotton, wool, acrylic, nylon, polyester, rubber, latex, nitril, etc. it can be made by weaving, knitting, or molding, dipping process.

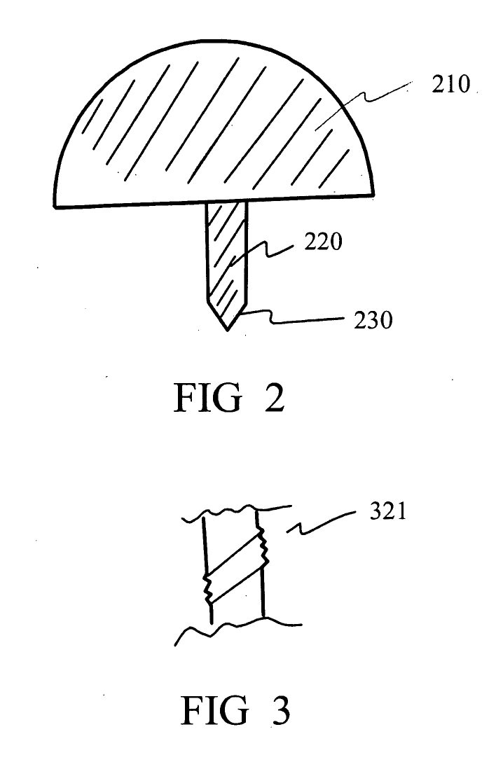

FIG. 2 is a cross-sectional view of a touch component with one embodiment of the invention. The touch component has two parts, tip 210 and root 220. It can be made by molding or mechanical process. Both materials are made of conductive materials. Some examples are, but not limited to, copper, iron, aluminum, steel, conductive polymer with carbon component, conductive polyacetylene polymer. The outer touch point component 210 may be manufactured to any type of shape. In some embodiments, the outer touch point top 210 may be designed to have a half ball shape, or ⅓ of a ball shape. In some embodiments, component 210 can have a flat surface with smooth edges. In some embodiments, the root of outer touch component has a sharp end 230 to assist the penetration through the barrier.

FIG. 3 is a cross-sectional view of an outer touch component root part with one embodiment of the invention. It has screw thread, 321, which can be trapped or locked by the other inner locking component.

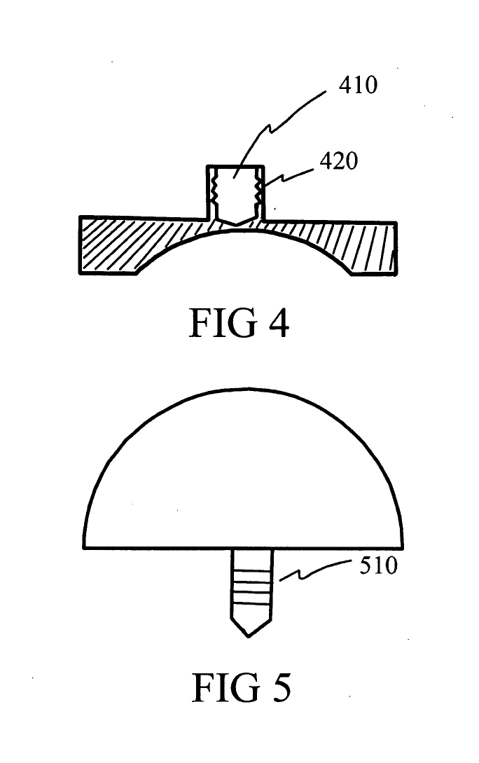

FIG. 4 is a cross-sectional view of an inner locking component with one embodiment of the invention. It has a screw hole, 410, that matches the screw thread 420 in outer touch component root.

FIG. 5 is a cross-sectional view of an outer touch component root part with one embodiment of the invention. It has etched lines 510.

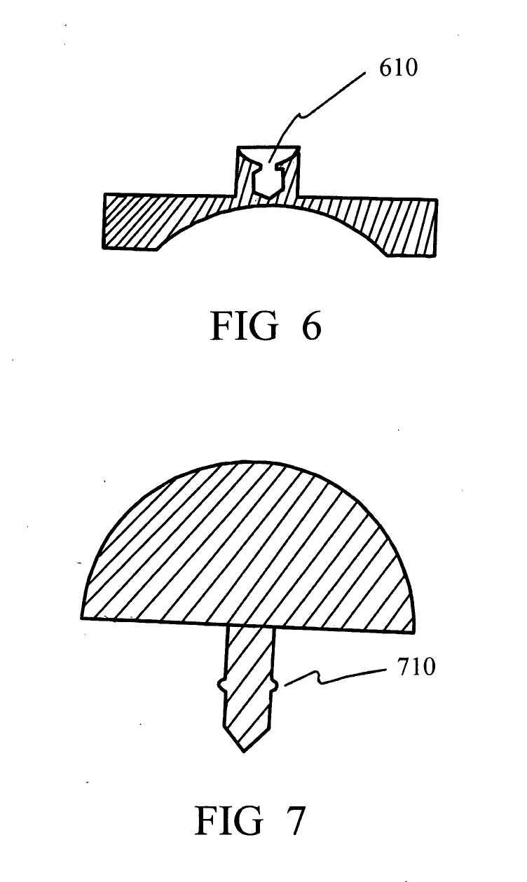

FIG. 6 is a cross-sectional view of an inner locking component with one embodiment of the invention. It has an aperture, 610, and its size is slightly smaller than the diameter of the outer touch component root, therefore it traps the root at the etched lines.

FIG. 7 is a cross-sectional view of an outer touch component root part with one embodiment of the invention. It has protruding dots, 710.

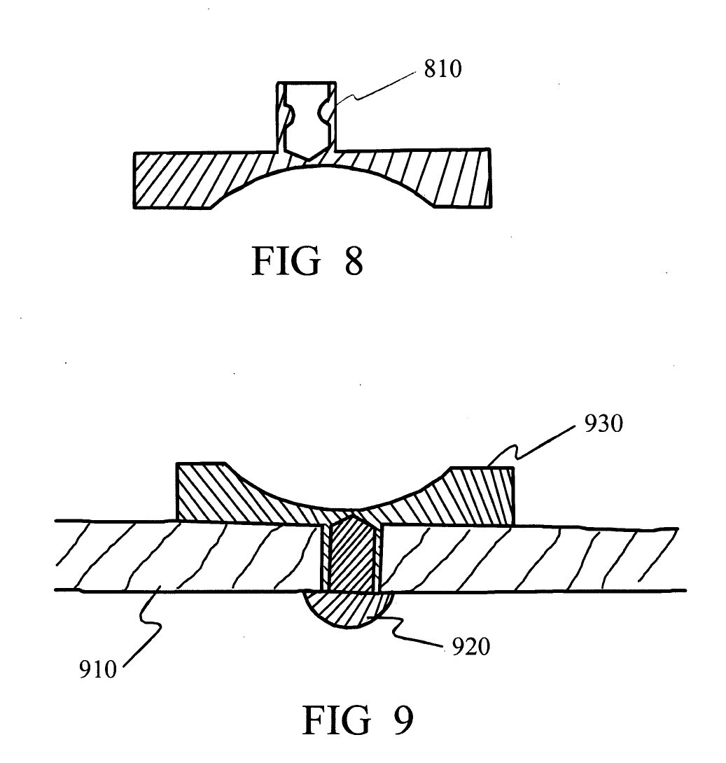

FIG. 8 is a cross-sectional view of an inner locking component with one embodiment of the invention. It has protruding dots, 810, to lock the outer touch component root when it enters into the locking component.

FIG. 9 is a cross-sectional view of an accessory set in use with one embodiment of the invention. The barrier layer, 910, is securely locked between the outer touch component, 920, and inner locking component, 930.

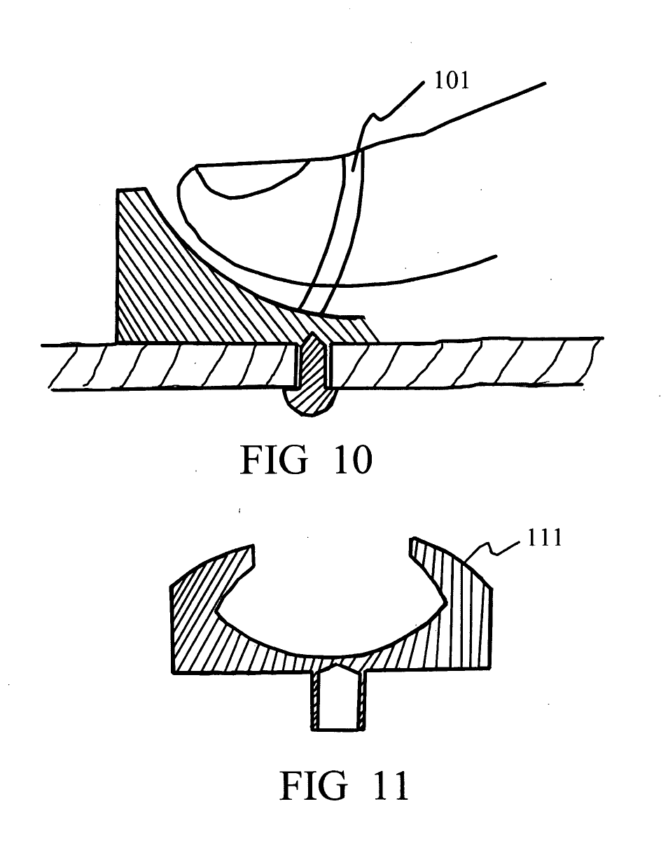

FIG. 10 is cross sectional view of an inner locking component with an elastic band or string, 101 that can secure finger during use. When needed, the finger can slide into the elastic band and “wear” the inner locking part to operate.

FIG. 11 is cross sectional view of an inner locking component with an edge 111 extending out in an angle to secure the finger during the electronic device operation.

In some embodiments, both components (100 and 200) may be constructed from a plastic material having low thermal conductivity but good electric conductivity.

Inner locking component 200 has thread, notch or protruding dots 210 that hold the outer point component root 110. The distance between outer pointer component and inner locking component can be adjusted by moving the outer point component up and down.

In some embodiments, the outer touch tip may be a flat surface or part of ball shape.

To prevent the possible heat or moisture transmission, a thin layer of glue can be applied to the surface connecter outer touching tip and the barrier substrate. The glue can be based on, but not limited to, polyurethane, polyacrylic, silicon, diethylene glycol, epoxies, etc. A coating with poor thermal transmission but with good conductivity can be used.

When the user wishes to remove the accessory from the substrate, it is possible to uninstall the outer touch tip and inner locking system with force.

In some embodiments, this accessory system can be introduced to the barrier system during the manufacturing process by the manufacturer, instead of users.

1. An accessory system for non electrically conductive barrier, comprising: an inner locking component; an outer touch component; a mechanism to tightly couple said inner locking component, said non-electrically conductive layer and said out touch component; a mechanism to allow electrons flow through said non-electrically conductive barrier.

2. The accessory system of claim 1, wherein both inner locking component and outer touch component are partially or wholly made of electrically conductive material that allows continuous electron flow from source of electrons to electronic device.

3. The source of electrons of claim 2 is finger.

4. The accessory system of claim 1 can be used to reduce static build-up without destroying the barrier material.

5. The accessory system can be installed at any location on the non electrically conductive barrier.

6. The non-electrically conductive barrier is a glove.

7. An use of the accessory system of claim 1 for a protective barrier to operate an electronic device.

8. The accessory system of claim 1 can be installed at any location.

9. The outer touch point of claim 1, further comprising a tactical and electrically conductive coating or cover on the outmost surface for use on electronic device.

10. The outer touch component and inner locking component of claim 1 are made of metal or other conductive materials.

11. The metal of claim 10 is copper.

12. The accessory system of claim 1, wherein the inner locking component comprising a surface that matches finger tip shape.

13. The accessory system of claim 1, wherein the coating or cover is conductive, with carbon or metal components in powder or thread form.

14. The accessory system of claim 1, further comprising a conductive coating or cover on the inner locking component.
